(19) United States
(12) Patent Application Publication
(10) Pub. No.: US 2009/0000727 A1
(43) Pub. Date: Jan. 1, 2009

(54) HARDCOAT LAYERS ON RELEASE LINERS

(76) Inventors: Kanta Kumar, Maplewood, MN (US); John P. Baetzold, North St. Paul, MN (US); Michael A. Semonick, White Bear Lake, MN (US)

Correspondence Address: 3M INNOVATIVE PROPERTIES COMPANY, PO BOX 33427, ST. PAUL, MN, 55133-3427, US

(21) Appl. No.: 11/771,705

(22) Filed: Jun. 29, 2007

(51) Int. Cl. B32B 27/00; B32B 33/00; B32B 7/04; B44C 1/165

(52) U.S. Cl. 156/230; 156/344; 427/457; 428/220; 428/32.39; 428/41.8; 428/98

(57) ABSTRACT

A hardcoat film article comprises a cured hardcoat layer disposed on a release liner. The release liner comprises a release material formed by irradiating a release material precursor, wherein the release material precursor has a shear storage modulus of about 1×10² to about 3×10⁶ Pa when measured at 20° C. and at a frequency of 1 Hz, and wherein the release material has a contact angle of 15° or more, as measured using a mixed solution of methanol and water (volume ratio 90:10) having a wet tension of 25.4 mN/m.

### FIELD

The present invention relates to hardcoat articles having a cured hardcoat layer disposed on a release liner that can be used, for example, in graphic applications, and to methods of making and using the hardcoat articles.

### BACKGROUND

Hardcoat surfaces can protect graphic substrates by providing abrasion and graffiti resistance. Typically, hardcoat surfaces are directly coated onto the graphic substrate. It can be desirable, however, in some graphic applications for the hardcoat to be transferred onto the graphic substrate at a later stage. A release surface or liner can be used to facilitate transfer of the hardcoat surface onto the graphic substrate. But, hardcoat solutions show poor wet-out on most commercially available release liners.

### SUMMARY

In view of the foregoing, we recognize that there is a need for cured hardcoat layers provided on release liners so that the hardcoat layers can be transferred onto graphic substrates at a later stage (for example, in a small graphic shop versus in the factory) in order to provide abrasion and graffiti resistance. Furthermore, we recognize that the hardcoat solution must exhibit good wet-out on the release liner in order to provide a smooth and uniform film that does not show many voids (that is, non-wets).

Briefly, in one aspect, the present invention provides a hardcoat film article comprising a cured hardcoat layer disposed on a release liner. The release liner comprises a release material formed by irradiating a release material precursor, which has a shear storage modulus of about 1×10² to about 3×10⁶ Pa when measured at 20° C. and at a frequency of 1 Hz. The release material has a contact angle of 15° or more, as measured using a mixed solution of methanol and water (volume ratio 90:10) having a wet tension of 25.4 mN/m.

It has been discovered that hardcoat solutions exhibit good wet-out on the described release liners and provide a smooth and uniform film. The cured hardcoat layer does not bond to the release liner. Therefore, the release liner can be easily removed (for example, peeled away) from the cured hardcoat layer. In addition, it has been discovered that when the hardcoat film articles of the invention are used to protect a graphic, higher gloss can be observed.

In another aspect, the present invention provides a method for making a hardcoat film article. The method comprises coating a hardcoat composition onto the release liner described above to form a hardcoat layer.

In yet another aspect, the present invention provides a method of using a cured hardcoat film article. The method comprises (a) providing a cured hardcoat film article comprising the release liner described above, a cured hardcoat layer disposed on the release liner, a thermoplastic layer comprising an ink receptive material on the cured hardcoat layer, and a graphic printed on the thermoplastic layer, and (b) removing the release liner.

### BRIEF DESCRIPTION OF DRAWINGS

FIG. 1 is a schematic diagram of a hardcoat film article of the invention.

FIG. 2 is a schematic diagram of a hardcoat film article of the invention comprising a thermoplastic layer.

FIG. 3 is a schematic diagram of a hardcoat film article of the invention comprising an adhesive layer and an optional second release liner.

### DETAILED DESCRIPTION

### Hardcoat Layer

The hardcoat film articles of the invention comprise a cured hardcoat layer disposed on a release liner. Preferably, the cured hardcoat layer is transparent. As used herein, “transparent” refers to a film layer having a thickness and when the film is disposed on a graphic substrate, an image (disposed on or adjacent the graphic substrate) is visible through the thickness of the transparent film layer. The hardcoat layer can be made from any suitably curable polymeric material. As used herein, “polymeric material” will be understood to include polymers, copolymers (for example, polymers formed using two or more different monomers), oligomers, and combinations thereof, as well as polymers, copolymers, or oligomers that can be formed in a miscible blend. An example of a suitable material for the hardcoat layer is a multifunctional or cross-linkable monomer.

Examples of cross-linkable monomers include multifunctional acrylates, urethanes, urethane acrylates, siloxanes, and epoxies. In some embodiments, cross-linkable monomers include mixtures of multifunctional acrylates, urethane acrylates, or epoxies.

Useful acrylates include, for example, poly(meth)acryl monomers such as, for example, di(meth)acryl containing compounds, tri(meth)acryl containing compounds, higher functionality (meth)acryl containing compounds and oligomeric(meth)acryl compounds.

Suitable di(meth)acryl containing compounds include 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, and tripropylene glycol diacrylate.

Suitable tri(meth)acryl containing compounds include glycerol triacrylate, trimethylolpropane triacrylate, ethoxylated triacrylates (for example, ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (for example, propoxylated (3) glyceryl triacrylate, propoxylated (5.5) glyceryl triacrylate, propoxylated (3) trimethylolpropane triacrylate, propoxylated (6) trimethylolpropane triacrylate), trimethylolpropane triacrylate, pentaerythritol triacrylate, and tris(2-hydroxyethyl)isocyanurate triacrylate.

Suitable higher functionality (meth)acryl containing compounds include ditrimethylolpropane tetraacrylate, dipentaerythritol pentaacrylate, ethoxylated (4) pentaerythritol tetraacrylate, pentaerythritol tetraacrylate, and caprolactone modified dipentaerythritol hexaacrylate.

Suitable oligomeric(meth)acryl compounds include urethane acrylates, polyester acrylates, epoxy acrylates; polyacrylamide analogues of the foregoing such as, for example, N,N-dimethyl acrylamide; and combinations thereof.

Many poly(meth)acryl monomers are widely available from vendors such as, for example, Sartomer Company, Exton, Pa.; UCB Chemicals Corporation, Smyrna, Ga.; and Aldrich Chemical Company, Milwaukee, Wis. Additional useful (meth)acrylate materials include hydantoin moiety-containing poly(meth)acrylates, for example, as described in U.S. Pat. No. 4,262,072 (Wendling et al.).

In an illustrative embodiment, the hardcoat layer includes a monomer having at least two or three (meth)acrylate functional groups. Commercially available cross-linkable acrylate monomers include those available from Sartomer Company, Exton, Pa. such as trimethylolpropane triacrylate available under the trade designation SR351, pentaerythritol triacrylate available under the trade designation SR444, dipentaerythritol triacrylate available under the trade designation SR399LV, ethoxylated (3) trimethylolpropane triacrylate available under the trade designation SR454, ethoxylated (4) pentaerythritol triacrylate, available under the trade designation SR494, tris(2-hydroxyethyl)isocyanurate triacrylate, available under the trade designation SR368, and dipropylene glycol diacrylate, available under the trade designation SR508.

Useful urethane acrylate monomers include, for example, a hexafunctional urethane acrylate available as Ebecryl™ 8301 from Radcure UCB Chemicals (Smyrna, Ga.), CN981 and CN981B88 available from Sartomer Company (Exton, Pa.), and a difunctional urethane acrylate available as Ebecryl™ 8402 from Radcure UCB Chemicals. In some embodiments the hardcoat layer resin includes both poly(meth)acrylate and polyurethane material, which can be termed a “urethane acrylate.”

In some embodiments, the hardcoat layer can include a plurality of inorganic nanoparticles. The inorganic nanoparticles can include, for example, silica, alumina, or zirconia (the term “zirconia” includes zirconia metal oxide) nanoparticles. In some embodiments, the nanoparticles have a mean diameter in a range from 1 to 200 nm, or 5 to 150 nm, or 5 to 125 nm. Nanoparticles can be present in an amount from 10 to 200 parts per 100 parts of hardcoat layer monomer.

Useful silica nanoparticles are commercially available from Nalco Chemical Co. (Naperville, Ill.) under the product designation NALCO COLLOIDAL SILICAS. For example, silicas include NALCO products 1040, 1042, 1050, 1060, 2327 and 2329. Useful zirconia nanoparticles are commercially available from Nalco Chemical Co. (Naperville, Ill.) under the product designation NALCO OOSSOO8.

Surface treating or surface modification of the nanoparticles can provide a stable dispersion in the hardcoat layer resin. The surface-treatment can stabilize the nanoparticles so that the particles will be well dispersed in the polymerizable resin and result in a substantially homogeneous composition. Furthermore, the nanoparticles can be modified over at least a portion of its surface with a surface treatment agent so that the stabilized particle can copolymerize or react with the polymerizable hardcoat layer resin during curing.

The nanoparticles can be treated with a surface treatment agent. In general a surface treatment agent has a first end that will attach to the particle surface (covalently, ionically or through strong physisorption) and a second end that imparts compatibility of the particle with the hardcoat layer resin and/or reacts with hardcoat layer resin during curing. Examples of surface treatment agents include alcohols, amines, carboxylic acids, sulfonic acids, phospohonic acids, silanes and titanates. The preferred type of treatment agent is determined, in part, by the chemical nature of the inorganic particle or metal oxide particle surface. Silanes are generally preferred for silica and zirconia. The surface modification can be done either subsequent to mixing with the monomers or after mixing.

In some embodiments, it is preferred to react silanes with the particle or nanoparticle surface before incorporation into the resin. The required amount of surface modifier is dependant upon several factors such as particle size, particle type, modifier molecular wt, and modifier type. In general it is preferred that approximately a monolayer of modifier is attached to the surface of the particle. The attachment procedure or reaction conditions required also depend on the surface modifier used. For silanes it is preferred to surface treat at elevated temperatures under acidic or basic conditions for approximately 1-24 hours approximately. Surface treatment agents such as carboxylic acids do not require elevated temperatures or extended time.

Surface modification of zirconia with silanes can be accomplished under acidic conditions or basic conditions. In one embodiment, silanes are preferably heated under acid conditions for a suitable period of time. At which time the dispersion is combined with aqueous ammonia (or other base). This method allows removal of the acid counter ion from the ZrO₂ surface as well as reaction with the silane. Then the particles are precipitated from the dispersion and separated from the liquid phase.

The surface modified nanoparticles can be incorporated into the curable resin by various methods. In one embodiment, a solvent exchange procedure is utilized whereby the resin is added to the surface modified nanoparticles, followed by removal of the water and co-solvent (if used) via evaporation, thus leaving the nanoparticles dispersed in the polymerizable resin. The evaporation step can be accomplished for example, via distillation, rotary evaporation or oven drying, as desired.

Representative examples of surface treatment agents suitable for inclusion in the hardcoat layer include compounds such as, for example, phenyltrimethoxysilane, phenyltriethoxysilane, 2-(3,4-epoxycyclohexyl)ethyltriethoxysilane, 2-(3,4-epoxycyclohexyl)ethyltrimethoxysilane, isooctyl trimethoxy-silane, N-(3-triethoxysilylpropyl)methoxyethoxyethoxyethyl carbamate (PEG3TES), Silquest A1230, N-(3-triethoxysilylpropyl)methoxyethoxyethoxyethyl carbamate (PEG2TES), 3-(methacryloyloxy)propyltrimethoxysilane, 3-acryloxypropyltrimethoxysilane, 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, 3-(methacryloyloxy)propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate, 2-(2-methoxyethoxy)acetic acid, methoxyphenyl acetic acid, and mixtures thereof.

A photoinitiator can be included in the hardcoat layer. Examples of initiators include organic peroxides, azo compounds, quinines, nitro compounds, acyl halides, hydrazones, mercapto compounds, pyrylium compounds, imidazoles, chlorotriazines, benzoin, benzoin alkyl ethers, di-ketones, phenones, and the like. Commercially available photoinitiators include those available commercially from Ciba Geigy under the trade designations Daracur™ 1173, Darocur™ 4265, Irgacure™ 651, Irgacure™ 184, Irgacure™ 1800, Irgacure™ 369, Irgacure™ 1700, Irgacure™ 907, Irgacure™ 819 and from Aceto Corp. (Lake Success, N.Y.) under the trade designations UV1-6976 and UV1-6992. Phenyl-[p-(2-hydroxytetradecyloxy)phenyl]iodonium hexafluoroantomonate is a photoinitiator commercially available from Gelest (Tullytown, Pa.). Phosphine oxide derivatives include Lucirin™ TPO, which is 2,4,6-trimethylbenzoy diphenyl phosphine oxide, available from BASF (Charlotte, N.C). In addition, further useful photoinitiators are described in U.S. Pat. Nos. 4,250,311, 3,708,296, 4,069,055, 4,216,288, 5,084,586, 5,124,417, 5,554,664, and 5,672,637. A photoinitiator can be used at a concentration of about 0.1 to 10 weight percent or about 0.1 to 5 weight percent based on the organic portion of the formulation (phr).

The hardcoat layer can be cured in an inert atmosphere. Curing the hardcoat layer in an inert atmosphere can assist in providing/maintaining the scratch and stain resistance properties of the hardcoat layer. In some embodiments, the hardcoat layer can be cured with an ultraviolet (UV) light source under a nitrogen blanket.

To enhance durability of the hardcoat layer, especially in outdoor environments exposed to sunlight, a variety of commercially available stabilizing chemicals can be added. These stabilizers can be grouped into the following categories: heat stabilizers, UV light stabilizers, and free-radical scavengers. Heat stabilizers can typically be present in amounts ranging from 0.02 to 0.15 weight percent. UV light stabilizers can be present in amounts ranging from 0.1 to 5 weight percent. Benzophenone type UV-absorbers are commercially available, for example, from Cytec Industries (West Patterson, N.J.) under the trade designation Cyasorb™ UV-1164, and Ciba Specialty Chemicals (Tarrytown, N.Y.) under the trade designations Tinuvin™ 900, Tinuvin™ 123 and Tinuvin™ 1130. Free-radical scavengers can be present in an amount from 0.05 to 0.25 weight percent. Nonlimiting examples of free-radical scavengers include hindered amine light stabilizer (HALS) compounds, hydroxylamines, sterically hindered phenols, and the like. HALS compounds are commercially available from Ciba Specialty Chemicals under the trade designation Tinuvin™ 292 and Cytec Industries under the trade designation Cyasorb™ UV-3581.

### Release Liners

The cured hardcoat layer described above is disposed on a release liner comprising a release material. Useful release materials can be formed by irradiating (for example, by using an UV ray or electron beam) a release materiel precursor having shear storage modulus of about 1×10² Pa to about 3×10⁶ Pa at 20° C. and a frequency of 1 Hz. The release material (after irradiation) has a contact angle of 15° or more, measured using a mixed solution of methanol and water (volume ratio 90:10) having a wet tension of 25.4 mN/m. Examples of suitable release material precursors include polymers having a shear storage modulus within the above-described range, such as, for example, a poly(meth)acrylic ester, a polyolefin, or a polyvinyl ether.

An example of a useful release material precursor is a copolymer having two kinds of acryl monomer components such as, for example, a (meth)acrylate containing an alkyl group having from about 12 to about 30 carbon atoms (hereinafter referred to as a “first alkyl(meth)acrylate”) and a (meth)acrylate containing an alkyl group having from 1 to about 12 carbon atoms (hereinafter referred to as a “second alkyl(meth)acrylate”).

The first alkyl(meth)acrylate contains a relatively long alkyl side chain having from about 12 to about 30 carbon atoms that helps to decrease the surface energy of the release material. Accordingly, the first alkyl(meth)acrylate acts to impart a low release strength to the release material. The first alkyl(meth)acrylate typically does not contain a polar group (for example, a carboxyl group, a hydroxyl group, or a nitrogen- or phosphorous-containing polar group) on the side chain. Accordingly, the first alkyl(meth)acrylate can impart relatively low release strength to the release material, not only at low temperatures, but also even after exposure to relatively high temperatures.

Preferred examples of the first alkyl(meth)acrylate having a long chain alkyl group include lauryl(meth)acrylate, cetyl(meth)acrylate, (iso)octadecyl(meth)acrylate, and behenyl(meth)acrylate. The first alkyl(meth)acrylate is typically present in an amount of about 10% to about 90% by weight based on the total amount of the first alkyl(meth)acrylate and the second alkyl(meth)acrylate.

The second alkyl(meth)acrylate contains a relatively short alkyl side chain having from 1 to about 12 carbon atoms. This relatively short alkyl side chain decreases the glass transition temperature of the release material to about 30° C. or less. In turn, the release material precursor is reduced in crystallinity and also in the shear storage modulus.

In one embodiment, the second alkyl(meth)acrylate containing an alkyl group having 12 carbon atoms is the same as the first alkyl(meth)acrylate having 12 carbon atoms. In this case, unless other components are present, the release material can be formed from a release material precursor containing a homopolymer.

Furthermore, the second alkyl(meth)acrylate typically does not contain a polar group on the side. Therefore, similarly to the first alkyl(meth)acrylate, the second alkyl (meth)acrylate imparts a relatively low release strength, not only at a low temperature, but also at a relatively high temperature.

Preferred examples of the second(meth)acrylate having a short chain alkyl group include butyl(meth)acrylate, hexyl(meth)acrylate, octyl(meth)acrylate, and lauryl (meth)acrylate. The second alkyl(meth)acrylate is typically present in an amount of about 10% to about 90% by weight based on the total amount of the first alkyl(meth)acrylate and the second alkyl(meth)acrylate.

The first and/or the second alkyl(meth)acrylates may be a (meth)acrylate having a branched side chain such as 2-heptylundecyl acrylate, 2-ethylhexyl(meth)acrylate, or isononyl(meth)acrylate. (Meth)acrylates having a branched side chain reduce the crystallinity and therefore decrease the shear storage modulus and the surface energy. A homopolymer consisting of a monomer component of alkyl(meth)acrylate containing a branched alkyl group having from about 8 to about 30 carbon atoms can be useful as the release material precursor. For example, a homopolymer of 2-heptylundecyl acrylate is a preferred release material precursor from the standpoint that the obtained release material can be reduced in surface energy and shear storage modulus. A copolymer comprising a monomer component of alkyl(meth)acrylate containing a straight alkyl group and a monomer component of alkyl(meth) acrylate containing a branched alkyl group having from about 8 to about 30 carbon atoms can also be useful as the release material precursor. For example, a copolymer of stearyl acrylate and isostearyl acrylate is also a preferred release material precursor from the standpoint that the obtained release material can be reduced in surface energy and shear storage modulus.

Preferred release material precursors can be obtained by polymerization of alkyl(meth)acrylates in the presence of a polymerization initiator. The polymerization initiator is not particularly limited as long as it can bring about the polymerization. Examples of useful polymerization initiators include azobis compounds such as 2,2′-azobisisobutyronitrile, 2,2′-azobis(2-methylbutylonitrile), and 2,2′-azobis(2-methylvaleronitrile and peroxides such as benzoyl peroxide and lauroyl peroxide. Some polymerization initiators are commercially available, such as 2,2′-azobisisobutyronitrile and 2,2′-azobis(2-methylbutylonitrile), which are available as V-60 and V-59 from Wako Pure Chemical Industries, Ltd. (Osaka, Japan). The amount of polymerization initiator can vary, but the polymerization initiator is typically used in an amount of about 0.005% to about 0.5% by weight based on the weight of the monomer.

The polymerization of the above-described alkyl(meth)acrylates can be performed by any known method. For example, a solution polymerization method, which involves dissolving the alkyl(meth)acrylates in a solvent and polymerizing them in solution can be used. The polymer solution can be directly taken out and used after the completion of polymerization. In this case, the solvent to be used is not particularly limited. Some examples of suitable solvents include ethyl acetate, methyl ethyl ketone, and heptane. A chain transfer agent can also be incorporated into the solvent in order to control molecular weight. The solution polymerization of the polymerizable composition can typically be performed at a reaction temperature of about 50° C. to about 100° C. for about 3 to about 24 hours in an atmosphere of an inert gas such as nitrogen.

When the release material precursor is a poly(meth)acrylate, the release material polymer typically has a weight average molecular weight of about 100,000 to about 2,000,000. If the weight average molecular weight is less than about 100,000, the release strength may increase, whereas if the weight molecular average molecular weight exceeds about 2,000,000, the viscosity of the polymer solution may be increased during synthesis, making handling of the polymer solution relatively difficult.

As long as the above-described physical properties can be attained, the release material can be constituted by a polyolefin. The polyolefin can be formed from an olefin monomer having from about 2 to about 12 carbon atoms. Examples of useful olefin monomers include linear olefins such as ethylene, propylene, 1-butene, 1-pentene, 1-hexene, 1-heptene, 1-octene, 1-nonene, 1-decene, 1-undecene, 1-dodecene, and branched olefins such as 4-methyl-1-pentene, 5-methyl-1-hexene, 4-methyl-1-hexene, 7-methyl-1-octene, and 8-methyl-1-nonene. However, a homopolymer of ethylene or propylene, namely polyethylene and polypropylene, generally cannot satisfy the physical properties of shear storage modulus because of their crystallinity. Therefore, when using ethylene, propylene, or the like, the shear storage modulus is typically decreased by copolymerization, for example, with 1-butene, 1-octene, or the like.

With respect to the copolymer structure, a random copolymer is preferred from the standpoint of reducing crystallinity. However, even if the copolymer has crystallinity, as long as the shear storage modulus is acceptable, a block copolymer can be used. The weight average molecular weight is typically from about 100,000 to about 2,000,000. Polyolefins having a high molecular weight can be produced by conventionally known polymerization methods such as, for example, ionic polymerization, preferably coordinated anionic polymerization.

Examples of useful commercially available polyolefins include ethylene/propylene copolymers are available from JSR Corporation (Tokyo, Japan) as EP01P and EP912P, and an ethylene/octene copolymer available from The Dow Chemical as Engage™ 8407.

The release material precursor can also be a polyvinyl ether having the above-described properties. Examples of the starting monomer for a polyvinyl ether include linear or branched vinyl ethers such as n-butyl vinyl ether, 2-hexyl vinyl ether, dodecyl vinyl ether, and octadecyl vinyl ether. However, for example, polyoctadecyl vinyl ether does not satisfy the above-described physical properties for the shear storage modulus. Therefore, when using octadecyl vinyl ether, the shear storage modulus is typically decreased by copolymerization, for example, 2-ethylhexyl vinyl ether.

With respect to the copolymer structure, a random copolymer is preferred from the standpoint of reducing crystallinity. However, even if the copolymer has crystallinity, as long as the shear storage modulus is acceptable, a block copolymer can be used. The weight average molecular weight is typically from about 100,000 to about 2,000,000. The polyvinyl ether can be produced by ionic polymerization such as, for example, by cationic polymerization.

The release material precursor can be provided on a liner substrate, preferably a liner substrate comprising polyester, polyolefin, or paper. The release material precursor can then be subjected to a treatment of radiation, for example, by using an electron beam or UV rays. The release material precursor generally has no polar functional groups such as carboxyl groups, hydroxyl groups, or amide groups. Therefore, it would be expected that the release material precursor would exhibit poor anchoring to the liner substrate. However, despite the absence of a polar functional group in the release material precursor, the anchoring between the liner substrate and the release material can be increased by treatment with radiation.

The release liner can be manufactured as follows. A solution of the release material precursor can be diluted with a diluent, for example, containing at least one of ethyl acetate, butyl acetate, methyl ethyl ketone, methyl isobutyl ketone, hexane, heptane, toluene, xylene, and methylene chloride, and then coated on a 1 to a predetermined thickness, thereby forming a release material precursor layer on the liner substrate. The diluent can be the same as or different than the solvent used in the solution polymerization.

Examples of liner substrates that can be used include plastics such as polyesters (for example, a polyethylene terephthalate, polyethylene naphthalate, or polybutylene terephthalate film) and polyolefins, and paper. The thickness of the release material precursor depends on the type of liner substrate but is generally from about 0.01 to about 1 μm (preferably, from about 0.05 to about 0.5 μm).

The release material precursor can be irradiated by, for example, an electron beam or ultraviolet ray. In the case of using an electron beam, the irradiation is typically performed under an inert gas such as nitrogen. The absorbed dose thereto depends on the thickness and composition of the release material precursor layer and is usually from about 1 to about 100 kGy. If an ultraviolet ray is used, the irradiation energy of the release material precursor layer is usually from about 10 to about 300 mJ/cm² (preferably, from about 20 to about 150 mJ/cm²).

An example of another useful release material precursor is an acrylic release agent precursor which comprises a poly(meth)acrylate ester having a group capable of being activated by ultraviolet radiation (also referred to as “an ultraviolet active group”) and has a shear storage modulus of about 1×10² to about 3×10⁶ Pa at 20° C. and a frequency of 1 Hz. The acrylic release agent precursor, after irradiation with ultraviolet radiation, has a contact angle of about 15° or more to a mixed solution of methanol and water (volume ration of 90:10) having a wetting tension of 25.4 mN/m.

The acrylic release agent precursor can be a polymer composition comprising a polymer such as poly(meth)acrylate ester having an ultraviolet active group. The poly(meth)acrylate is, for example, a copolymer formed from a first alkyl(meth)acrylate as described above, a second alkyl(meth)acrylate as described above, and a (meth)acrylate ester having an ultraviolet active group.

Preferred first alkyl(meth)acrylates containing a long alkyl side chain for the acrylic release agent precursor include lauryl(meth)acrylate, cetyl(meth)acrylate, stearyl (meth)acrylate, and behenyl(meth)acrylate.

The copolymer typically contains the first alkyl(meth)acrylate or second alkyl (meth)acrylate in an amount from about 10 to about 90% by weight based on the total weight of the first and second alkyl(meth)acrylates.

The poly(meth)acrylate ester can also be derived from a monomer component containing an alkyl(meth)acrylate having a branched alkyl group having from about 8 to about 30 carbon atoms and a (meth)acrylate ester having an ultraviolet active group. Examples of suitable alkyl(meth)acrylate having a branched alkyl group include 2-ethylhexyl(meth)acrylate, 2-hexyldodecyl acrylate, 2-heptylundecyl acrylate, 2-octyldecyl acrylate, and isononyl(meth)acrylate.

Such a (meth)acrylate having a branched side chain can reduce the shear storage modulus and surface energy by lowering the crystallinity. Thus, it is not necessary for the acrylic release agent precursor to contain two components such as a first alkyl (meth)acrylate and a second alkyl(meth)acrylate described above if it has a branched alkyl group having from about 8 to about 30 carbon atoms. For example, the polymer of 2-hexyldecyl acrylate or 2-octyldecyl acrylate can reduce the surface energy of the release agent.

Typically, the monomer component has no polar groups on the side chain. However, the monomer component may, for example, have a polar functional group on the side chain as long as the acrylic release agent precursor has a shear storage modulus as described above.

The poly(meth)acrylate ester has an ultraviolet active group. This ultraviolet active group can generate a free radical in the acrylic release agent precursor by irradiation with ultraviolet radiation. The generated free radical promotes crosslinking of the acrylic release agent precursor and adhesion to the liner substrate, resulting in an improvement in adhesion between the liner substrate and the release agent. Preferably, the amount of the (meth)acrylate ester having an ultraviolet active group is within a range of about 0.01 to about 1% by weight per poly(meth)acrylate ester unit.

The ultraviolet active group is not specifically limited, but is preferably derived from benzophenone or acetophenone. Introduction of the ultraviolet active group into the poly(meth)acrylate ester can be conducted by incorporating a (meth)acrylate ester having an ultraviolet active group as a monomer component and polymerizing the monomer component containing the (meth)acrylate ester.

The polymer of the acrylic release agent precursor preferably has a weight-average molecular weight within a range from about 100,000 to about 2,000,000.

The monomer component described above can be polymerized in the presence of a polymerization initiator to form an acrylic release agent precursor. Preferably, the polymerization is solution polymerization. Solution polymerization can typically be conducted in the state where the monomer component is dissolved in a solvent, together with the polymerization initiator, in an atmosphere of an inert gas such as nitrogen at about 50° to about 100° C. Solvents such as, for example, ethyl acetate, methyl ethyl ketone, or heptane can be used. Optionally, the molecular weight of the polymer can be controlled by adding a chain transfer agent to the solvent.

The polymerization initiator is not specifically limited. For example, an azobis compound such as 2,2′-azobisisobutyronitrile, 2,2′-azobis(2-methylbutyronitrile) or 2,2′-azobis(2,4-dimethylvaleronitrile), dimethyl 2,2′-azobis(2-methylpropionate) and a peroxide such as benzoyl peroxide or lauroyl peroxide can be used as the polymerization initiator. Preferably, the polymerization initiator is used in the amount within a range from 0.005 to 0.5% by weight based on the total weight of the monomer component.

The acrylic release agent precursor as described above is converted into an acrylic release agent by irradiating with ultraviolet radiation, after the precursor is coated on a liner substrate. Typically, the acrylic release agent is formed on the liner substrate in the thickness within a range from 0.01 to 1 μm. The acrylic release agent is generally obtained by irradiating with ultraviolet radiation after coating with the acrylic release agent precursor. As disclosed in WO 01/64805 and/or KOKAI (Japanese Unexamined Patent Publication) No. 2001-240775, the acrylic release agent adheres to the liner substrate by the irradiation with ultraviolet radiation, even though the acrylic release agent typically has no polar functional group. The liner substrate can be, for example, a film made of plastic such as polyester or polyolefin (for example, polyethylene terephthalate, polyethylene naphthalate or polybutylene terephthalate) or a paper. Preferred thickness of the liner substrate is within a range from about 10 to about 300 μm.

Usually, the acrylic release agent precursor is produced by solution polymerization as described above and exists in the state of a polymer solution. Therefore, the liner substrate can be coated with the polymer solution in a thickness typically within a range from about 0.01 to about 1 μm (preferably from 0.05 to 0.5 μm), using coating means such as bar coater. If necessary, the polymer solution can be applied after diluting with a diluent until a predetermined viscosity is achieved. Examples of the diluent include ethyl acetate, butyl acetate, methyl ethyl ketone, methyl isobutyl ketone, hexane, heptane, toluene, xylene, and methylene chloride.

The acrylic release agent precursor applied as described above is converted into an acrylic release agent by irradiation with ultraviolet radiation. The dose of irradiation with ultraviolet radiation varies depending on the kind and structure of the poly(meth)acrylate, but can usually be a low dose within a range from 10 to 150 mJ/cm².

### Hardcoat Film Articles

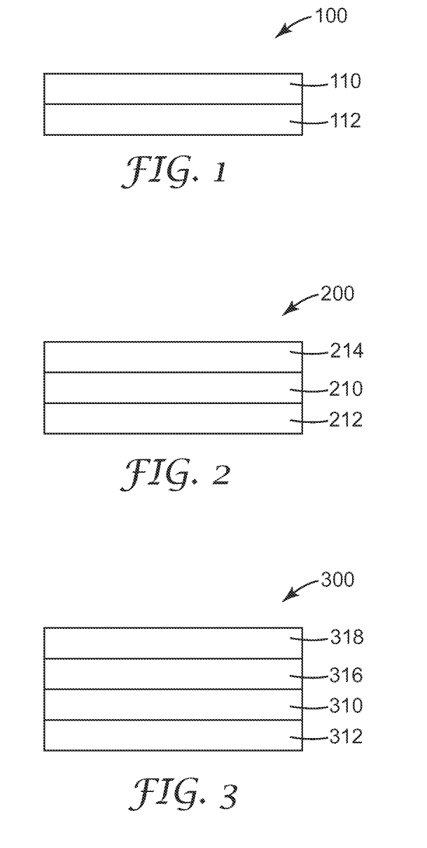

FIG. 1 depicts a hardcoat film article of the invention. Hardcoat film article 100 includes cured hardcoat layer 110 disposed on release liner 112. A hardcoat solution can be coated onto release liner 112 using coating methods known in the art. The hardcoat solution can be coated from an emulsion, a solvent (for example, organic solvent) mixture, or as 100% solids onto release liner 112.

The thickness of cured hardcoat layer 110 can be any useful thickness. In some embodiments, cured hardcoat layer 110 has a thickness in a range from about 1 to about 25 micrometers (preferably, about 1 to about 15; more preferably, about 1 to about 10; even more preferably, about 1 to about 5 micrometers).

The hardcoat film articles of the invention can further comprise a thermoplastic layer. As illustrated in FIG. 2, hardcoat film article 200 comprises thermoplastic layer 214 disposed on cured hardcoat layer 210. Thermoplastic layer 214 can include a transparent thermoplastic polymer such as, for example, a transparent polyacrylate or a derivative thereof. Other suitable thermoplastic polymers include polypropylene, polyacetal, polyamide, polyester, polystyrene, polyvinyl chloride, polyvinylidene chloride, polyurethane, polyurea, and the like.

The thickness of thermoplastic layer 214 can be any useful thickness. In some embodiments, thermoplastic layer 214 has a thickness of about 0.5 to about 20 micrometers (preferably, about 0.5 to about 5; more preferably, about 0.5 to about 3; even more preferably, 1 to about 3 micrometers).

In some embodiments, cured hardcoat layer 210 and thermoplastic layer 214 have a combined film thickness of about 1.5 to about 25 micrometers (preferably, about 1.5 to about 15; more preferably, about 1.5 to about 10 micrometers).

Thermoplastic layer 214 can include an ink receptive material or thermoplastic layer 214 can include an ink receptive layer. An ink receptive layer or material is a layer or material is a layer or material that is receptive to UV ink and/or solvent-based ink-jet ink. As used herein, “solvent-based” means non-aqueous. An ink receptive layer includes a blend of a carrier resin and an ink absorptive resin. The carrier resins described herein are thermoplastic polymers. The carrier resin can be any thermoplastic resin or blend of resins that is compatible with the ink absorptive resin.

The ink receptive material is derived from and thus comprises urethane-containing polymeric resins. As used herein, “base polymer” refers to a single urethane-containing copolymer such as a urethane acrylic copolymer optionally blended with a polyurethane polymer or an acrylic polymer, a blend of at least polyurethane polymer and at least one acrylic polymer, a blend of at least two polyurethane polymers, and mixtures thereof. The urethane-containing base polymer can also optionally be crosslinked. The blend of polymers can form a homogeneous mixture or can be multiphase, exhibiting two or more distinct peaks when analyzed via differential scanning calorimetry (DSC). Further, the ink receptive composition can comprise an interpenetrating network of the base polymer in an insoluble matrix or vice-versa. At least the urethane portion of the ink receptive coating is substantially insoluble in the ink composition (for example, solvent of the ink).

The ink receptive material includes a urethane-containing copolymer. As used herein, “urethane-containing copolymer” refers to a polymer having urethane segments and segments of at least one polymeric material that is different than a urethane. Urethane acrylic copolymers include those commercially available from Neoresins, Inc. (Wilmington, Mass.) under the trade designation NeoPac™ R-9000. The urethane acrylic copolymer can be employed alone or optionally in combination with at least one polyurethane polymer or at least one acrylic polymer.

In some embodiments, the ink receptive coatings are preferably derived from a blend comprising at least two polyurethane polymers or at least one polyurethane polymer and at least one acrylic polymer. Aliphatic polyurethanes typically exhibit greater durability, resistance to yellowing, etc. and are thus preferred. Examples of useful aqueous polyurethane dispersions include those commercially available from Neoresins under the trade designations NeoReZ™ R-960, NeoReZ™ R-966, NeoReZ™ R-9637, NeoReZ™ R-600, NeoReZ™ R-650, NeoReZ™ R-989, and NeoRez R-9679.

The concentration of polyurethane in the ink receptive material generally ranges from about 40 weight % to about 90 weight % solids (that is, the weight of the polyurethane after evaporation of water and/or solvent of the polyurethane emulsion or dispersion relative to the content of the other solid materials in the formulation). Preferably, the amount of polyurethane in the polyurethane/acrylic blend is at least about 50 weight % (more preferably, at least about 60 weight %).

In other embodiments, ink receptive coatings further include at least one acrylic polymer. The amount of acrylic polymer generally ranges from about 10 weight % to about 60 weight % solids. Various acrylic resins are known. A particularly suitable water-based acrylic emulsion is commercially available from Neoresins under the trade designation NeoCryl™ A-612 (reported to have a Konig Hardness of 75 at 144 hours).

Preferred blends comprising a polyurethane polymer and an acrylic polymer include mixtures of NeoRez™ R-960 and/or NeoReZ™ R-966 with NeoCryl™ A-612 (acrylic) wherein the proportion of polyurethane to acrylic is about 2:1. NeoReZ™ R-9679 is also suitable in place of NeoRez™ R-960 at slightly lower concentrations of polyurethane (for example, weight ratio of about 55:45). Another preferred composition includes NeoReZ™ R-600 and NeoCryl™ A-612 at a ratio of about 4:1.

In one embodiment, ink receptive materials include a blend of at least two polyurethane polymers such as a mixture of NeoRez™ R-960 and NeoReZ™ R-989 at a ratio of about 9:1.

The base polymer of the ink receptive material has a solubility parameter, molecular weight, and glass transition temperature (Tg) within a specified range. As used herein, “molecular weight” refers to weight average molecular weight (Mw) unless specified otherwise. In many embodiments, the base polymer and the thermoplastic polymer are formed of the same material and can be the same material.

The solubility parameter of the base polymer of the ink receptive material as well as the ink composition ink jetted onto the coated graphic substrate can vary, typically ranging from about 7 (cal/cm³)^{1/2} to about 12 (cal/cm³)^{1/2}. In some embodiments, the solubility parameter of both the ink and ink receptive material is at least about 8 (cal/cm³)^{1/2} and less than about 10 (cal/cm³)^{1/2}. The solubility of various pure materials, such as solvents, polymers, and copolymers as well as mixtures is known. The solubility parameters of such materials are published in various articles and textbooks. In the present invention, the terminology “solubility parameter” refers to the Hildebrand solubility parameter which is a solubility parameter represented by the square root of the cohesive energy density of a material.

The base polymer has a weight average molecular weight (Mw) as measured by Gel Permeation Chromatography (GPC) of greater than about 60,000 g/mole, or greater than about 80,000 g/mole, or greater than about 100,000 g/mole. Water-borne polymeric materials as well as aqueous dispersions and emulsions often contain polymeric materials having a relatively high Mw, ranging from greater than 400,000 to 1,000,000 or more.

In addition to the previously described solubility parameter and Mw, the base polymer of the ink receptive material ranges in glass transition temperature (Tg), as measured according to Differential Scanning Colorimetry (DSC) from about 30° C. to about 95° C. or from about 50° C. to about 80° C. Although the polyurethane alone may have a Tg of less than about 30° C., the presence of the higher Tg acrylic polymer ensures that the Tg of the blend is within the specified range. At a Tg of greater than about 95° C., the solvent of the ink generally does not significantly penetrate into the ink receptive material. These ink receptive materials are disclosed in U.S. Pat. No. 6,881,458 and are incorporated by reference herein, to the extent it does not conflict.

To enhance durability of the ink receptive thermoplastic layer and/or thermoplastic layer, especially in outdoor environments exposed to sunlight, a variety of commercially available stabilizing chemicals can be added. In general, the ink receptive layer and/or thermoplastic layer can be substantially free of colorant until it is printed with an image. However, it may also contain colorants to provide a uniform background colored film.

Surface treatments can sometimes be useful to secure adhesion between thermoplastic layer 214 (and/or ink receptor layer) and cured hardcoat layer 210. Surface treatments include, for example, chemical priming, corona treatment, plasma or flame treatment. A chemical primer layer or a corona treatment layer can be disposed between thermoplastic layer 214 (and/or ink receptor layer) and cured hardcoat layer 210. A chemical primer layer or a corona treatment layer can be disposed on one or both thermoplastic layer 214 (and/or ink receptor layer) and cured hardcoat layer 210. When a chemical primer layer and/or corona treatment is employed, inter-layer adhesion between thermoplastic layer 214 (and/or ink receptor layer) and cured hardcoat layer 210, can be improved.

Suitable chemical primer layers can be selected from urethanes, silicones, epoxy resins, vinyl acetate resins, ethyleneimines, and the like. Examples of chemical primers for vinyl and polyethylene terephthalate films include crosslinked acrylic ester/acrylic acid copolymers disclosed in U.S. Pat. No. 3,578,622. The thickness of the chemical primer layer is suitably within the range of about 10 to about 3,000 nanometers.

Corona treatment is a useful physical priming suitably applied to cured hardcoat layer 210 onto which is then coated thermoplastic layer 214 (and/or ink receptor layer). Corona treatment (or coating an additional prime layer) can improve the inter-layer adhesion between thermoplastic layer 214 and cured hardcoat layer 210.

The hardcoat film articles of the invention can be used to protect a substrate. In some embodiments, an adhesive (for example, a pressure sensitive adhesive) can be used to adhere the hardcoat film article to the substrate that is to be protected. The adhesive can be disposed on the substrate.

Alternatively, the adhesive can be disposed on at least a portion of the cured hardcoat layer, as illustrated in FIG. 3. Hardcoat film article 300 includes cured hardcoat layer 310 disposed on release liner 312 and adhesive layer 316 (and an optional second release liner 318) disposed on cured hardcoat layer 310. Optional second release liner 318 can be removed to reveal adhesive layer 316 so that adhesive layer 316 can be used to adhere hardcoat film article 300 to a substrate. The substrate can be, for example, a graphic substrate. The graphic substrate can be formed from any suitable graphic material. In many embodiments, the graphic substrate is a conformable material such as, for example, a polymer film. In some embodiments, the graphic substrate is a vinyl film such as, for example, a polyvinyl chloride film. In some embodiments, the graphic substrate includes an image disposed on or in the graphic substrate. In some embodiments, the graphic substrate contains colorants to provide a uniform background colored film. Once hardcoat film article 300 is adhered to a substrate, release liner 312 can be removed.

In some embodiments, a hardcoat film article of the invention (for example, hardcoat film article 200) can be used to protect a graphic substrate by laminating the cured hardcoat article onto a graphic substrate with heat and pressure. Thermoplastic layer 214 (and/or ink receptive layer) softens with the application of heat and adheres to the graphic substrate to form a protected graphic substrate.

Alternatively, hardcoat film article 200 can further comprise an adhesive layer (not shown) on at least a portion of thermoplastic layer 214 (and/or ink receptive layer) and an optional second release liner (not shown) so that hardcoat film article 200 can be adhered to a substrate.

In some embodiments, an adhesive such as, for example, a pressure sensitive adhesive can be disposed on a graphic substrate for application to a display substrate. Illustrative display substrates includes for example, building surfaces, vehicle surfaces or other graphic display surfaces.

The cured hardcoat film articles of the invention provide flexibility for various graphic applications that require abrasion and graffiti resistance. The release liner can easily be removed from the article. Therefore, the hardcoat can be transferred at any desired stage.

### EXAMPLES

Objects and advantages of this invention are further illustrated by the following examples, but the particular materials and amounts thereof recited in these examples, as well as other conditions and details, should not be construed to unduly limit this invention.

### Preparation of Release Material Precursor

In a 500 ml brown glass bottle, 100 parts of NK ester isostearyl acrylate (manufactured by Osaka Organic Chemical Industry LTD.), 100 parts of NK ester stearyl acrylate (manufactured by Osaka Organic Chemical Industry LTD.) and 0.4 parts of Ebecryl™ P36 (photoinitiator, manufactured by Daicel-UCB Company LTD.) were added to a mixed solvent containing ethyl acetate and n-heptane in a weight ratio of 50:50 to prepare a reaction solution having a solid content of 60% by weight. Then, 0.3 parts of a dimethyl 2,2′-azobis(2-methylpropionate) initiator (V-601 available from Wako Chemicals, USA Inc.), was added to this bottle. After this, the contents of this bottle were purged with a nitrogen gas for 10 minutes and sealed with a cap. This sealed bottle was transferred to a rotary constant-temperature bath maintained at 60° C. and allowed to stand therein for 24 hours. The material thus produced was used as a release material precursor.

### Preparation of Release Liner

The acrylic release material precursor was diluted with a 50:50 blend of toluene and n-heptanes to prepare a diluted solution at 2.0% solids by weight. A 50 μm thick polyester(polyethylene terephthalate) film was coated with the diluted solution, using a #3 bar coater, and dried to remove the solvents and obtain an acrylic release material precursor layer having a thickness of about 0.1 μm on the film.

Using a high-pressure mercury lamp (H type) manufactured by Fusion Systems Corporation, the acrylic release material precursor was irradiated with ultraviolet (UV) radiation with an energy density of 120 mJ/cm² under nitrogen to give a release liner sheet.

### Preparation of Hardcoat (HC) Solutions

### HC Formulation 1

In a round-bottomed flask were mixed 1195 grams Nalco™ 2327 silica sol (an ammonium ion-stabilized dispersion having a pH of 9.3 of colloidal silica particles, 40 percent solids, with an average particle diameter of 20 nanometers commercially available from Nalco Chemical Co.); 118 grams N,N-dimethyl acrylamide (commercially available from Aldrich Chemical Co); 120 grams 3-(trimethoxysilyl)propyl methacrylate coupling agent (commercially available from Aldrich Chemical Co.); and 761 grams pentaerythritol triacrylate (SR444 available from Sartomer Company, West Chester, Pa.) The round-bottomed flask was subsequently mounted on the vacuum line of a Buchi R152 Rotavapor, (commercially available from Buchi Laboratory AG, Flanil, Switzerland) with the bath temperature set to 55° C. A refrigerated mixture of 50 percent deionized water/50 percent antifreeze, was recirculated through the cooling coils. Volatile components were removed at a reduced pressure of 25 Torr until the distillation rate was reduced to less than 5 drops per minute (approximately 2 hours.) The resulting material (1464 grams) was a clear liquid dispersion of acrylated silica particles in a mixture of N,N-dimethyl acrylamide and pentaerythritol triacrylate monomers (a ceramer composition). To this mixture was added 1282 grams of isopropanol, 87 grams of water, 29 grams of Tinuvin™ 292 (bis(1,2,2,6,6-pentamethyl-4-piperidyl) sebacate and methyl 1,2,2,6,6-pentamethyl-4-piperidyl sebacate, available from Ciba Specialty Chemicals), and 36 grams of Irgacure™ 184. The final composition was ˜50% solids and was amber to hazy in appearance.

### HC Formulation 2

Hardcoat Formulation 2 was prepared by combining 50.0 parts SR295 (pentaerythritol tetraacrylate available from Sartomer Company, Inc.), 50.0 parts SR238 (1,6 hexandiol diacrylate available from Sartomer Company, Inc.), 6.0 parts Tinuvin™ 928 (2-(2H-benzatriazol-2-yl)-6-(1-methyl-phenylethyl)-4-(1,1,3,3-tetramethylbutyl)phenol available from Ciba Specialty Chemicals), 1.0 parts Irgacure™ 819 (Bis(2,4,6-trimethylbenzoyl)-phenylphosphineoxide, available from Ciba Specialty Chemicals), 0.5 parts Tinuvin™ 123 (Decanediodic acid, bis(2,2,6,6-tetramethyl-1-(octyloxy)-4-piperidinyl) ester, reaction products with 1,1-dimethylethylhydroperoxide and octane, available from Ciba Specialty Chemicals), and 0.5 parts Ebecryl™ 350 (silicone diacrylate additive, available from UBC Chemical Corp.). The components were thoroughly admixed and heated until all components were in solution.

### HC Formulation 3

Hardcoat Formulation 3 was prepared by combining 35.0 parts SR444 (pentaerythritol triacrylate available from Sartomer Company, Inc.), 65.0 parts C-N981 (aliphatic polyester/polyether based urethane diacrylate oligomers, available from Sartomer Company, Inc.), 6.0 parts Tinuvin™ 928, 1.0 parts Irgacure™ 819, 0.5 parts Tinuvin™ 123, and 0.5 parts Ebecryl™ 350. The components were thoroughly admixed and heated until all components were in solution.

### HC Formulation 4

Curable polyurethane acrylate hardcoat formulation was prepared by blending the functionalized particles with polyurethanes as described below. Functionalized (surface modified) silica nanoparticles for this formulation were prepared by the following method:

5.1 grams (gm) of ammonium fluoride was dissolved in 20 gm water. A 12-liter resin flask was equipped with a reflux condenser and mechanical stirring (pitched turbine blade on the end of a stainless steel shaft). It was then charged with 4000 gm of Nalco 1042 silica sol (20 nm particles, 34.7% w/w silica; 1388 gm silica), 3600 gm ethyl acetate, 346 gm methacryloyloxypropyl(trimethoxy)silane, and 400 gm more ethyl acetate (used to rinse the silane addition flask into the reaction flask). The aqueous ammonium fluoride solution was added to the reaction flask and stirring immediately started. An additional 20 gm water was used to rinse the ammonium fluoride addition flask into the reaction flask. The reaction was heated with a heating mantle. Roughly 5-10 minutes past ammonium fluoride addition, the reaction mixture began to form a gel, then white solids. After 20 minutes, there was a freely stirring white mixture in the reaction flask. The reaction was stirred at reflux for 20 hours, and then ambiently cooled for 2 hours. 1000 gm sodium chloride was added and the mixture stirred for 45 minutes. Stirring was halted, and phases were allowed to separate. The ethyl acetate phase was collected, dried with magnesium sulfate, and then filtered to give 3975 gm of 29.0% w/w functionalized silica in ethyl acetate (% solids determined by oven drying at 150 degrees Celsius for an hour). This ethyl acetate dispersion had a bluish opalescence.

The final formulation was prepared by combining 15 parts of Ebecryl™ 8301 (hexafunctional urethane acrylate available from Radcure UCB Chemicals, Smyrna, Ga.), 15 parts of Ebecryl™ 8401 (difunctional urethane acrylate available from Radcure UCB Chemicals), 53.8 parts of above prepared functionalized silica particles, 14.3 parts of ethyl acetate and 1.8 parts of Irgacure™ 184.

### Preparation of Hardcoat (HC) Transferable Articles

A hardcoat film article was prepared by coating HC Formulations onto the release liner sheet prepared as described above by using a #3 wire wound bar (R.D.S., Webster, N.Y.). The coated film was cured using a high-pressure mercury lamp (H type) manufactured by Fusion Systems Corporation with ultraviolet (UV) radiation energy density of 164 mJ/cm² to give a cured hardcoat on release liner sheet.

### Visual Determination of Coating Quality

The coated hardcoat film was evaluated visually to look for voids and transparency. Any voids or de-wets in the coated and cured film indicated poor quality of the final film. Results of the visual determination of Examples 1-4 are recorded in Table 1.

### Peel Force Measurement

The peel force of the hardcoat from the respective release liner sheets was determined in the following manner. Hardcoat transferable articles prepared above were laminated with 1.5″ (3.8 cm) wide 3M™ Scotch™ 845 Book Tape (available from 3M Co.). Hardcoat The tape was used as a reinforcing film, which allows the easy measurements of peel force for the hardcoat from release liner surface. The samples were cut to 1″ (2.5 cm) strip and peel force was measured by continuously peeling away the reinforced hardcoat at a peel angle of 180° and a peeling rate of 90 inch/min (229 cm/min) using an Imass SP2000 (available from IMASS Inc., Accord, Mass.). Peel forces obtained for each HC formulation (Examples 1-4) are recorded in Table 1.

TABLE 1

| | | Visual | Peel Force | |
|---|---|---|---|---|
| Example No. | HC Formulation | Appearance | (g/in) | (g/cm) |
| 1 | 1 | Good | 9.43 | 3.71 |
| 2 | 2 | Good | 10.97 | 4.32 |
| 3 | 3 | Good | 9.13 | 3.59 |
| 4 | 4 | Good | 10.00 | 3.94 |

### Comparative Example 1

HC Formulation 1 was coated onto a Clearsil™ silicone release liner T-50 (available from CPFilms Inc., Martinville, Va.) using a #3 wire wound bar (R.D.S., Webster, N.Y.). The coated film was not a continuous film and showed voids.

### Comparative Example 2

HC Formulation 2 was coated onto a Clearsil™ silicone release liner T-50 (available from CPFilms Inc., Martinville, Va.) using a #3 wire wound bar (R.D.S., Webster, N.Y.). The coated film was not a continuous film and showed voids.

### Comparative Example 3

HC Formulation 3 was coated onto a Clearsil™ silicone release liner T-50 (available from CPFilms Inc., Martinville, Va.) using a #3 wire wound bar (R.D.S., Webster, N.Y.). The coated film was not a continuous film and showed voids.

### Comparative Example 4

HC Formulation 3 was coated onto a silicone polyester release liner 7320 (available from Loparex Inc., Willowbrook, Ill.) using a #3 wire wound bar (R.D.S., Webster, N.Y.). The coated film was not a continuous film and showed voids.

Release from Release Liner Sheet

The following example describes preparing a hardcoat onto release liner sheet, further coating, and subsequently laminating to vinyl. After lamination the hardcoat was found to transfer easily from the liner, leaving a continuous film on the vinyl substrate.

Hardcoat Formulation 3 was coated onto the acrylic liner sheet using a #6 wire wound bar (R.D.S., Webster, N.Y.). The coated film was placed on a metal plate and cured with ultraviolet (UV) light through the hardcoat layer by irradiation with a 10 inch (25.4 cm) Fusion D lamp (Fusion Systems Corp., Rockville, Md.) set at 600 watts/inch (236 watts/cm) (100% power) and using nitrogen inerting sufficient to bring the oxygen level below 100 ppm. The web speed was 25 feet per minute (7.6 m/min). The cured film was then corona treated in an air atmosphere using an Eni Power Systems Model RS-8 Surface Treater (Eni Power Systems, Rochester, N.Y.) at a setting of 500 Watts at 10 feet/min (3 m/min). The corona treated film was coated with 3M™ 94 Tape Primer (3M Co.) using a #6 wire wound bar (R.D.S., Webster, N.Y.) and dried in a 150° F. (66° C.) oven for 1 minute. The primer coated film was then coated with a resin solution formed by thoroughly mixing 10.0 wt-% Paraloid™ B-82 acrylic resin (Rohm and Haas Co., Philadelphia, Pa.) and 90.0 wt-% 3M™ Thinner CGS-10 (1-methoxy-2-propyl acetate) (3M Co.). The resin solution was coated onto the primer coated film using a #6 wire wound bar and dried in a 150° F. (66° C.) oven for one minute. The resultant coated film was then placed face to face with a sheet of 3M™ Controltac™ Plus Graphic Film Series 180-10 (2 mil thick white vinyl film; “180 Vinyl Film“; 3M Co.) and run through an Orca 1 Laminator (Pro Tech Engineering, Madison, Wis.) at 2 feet per minute (0.6 m/min) and a nip pressure of 50 psi (345 kPa). The laminator top roll temperature was 225° F. (107° C.) and the bottom roll temperature was set at 36° F. (2° C.) (the temperature was variable, since no cooling was provided). The resultant laminated construction was allowed to cool to ambient temperature. The release liner sheet was then peeled back, leaving the construction on the 180 Vinyl Film. The release liner sheet allowed for easy release of the hardcoat with complete transfer taking place to the vinyl substrate.

### Gloss Measurement

Hardcoat Formulation 3 was coated onto a UV crosslinked acrylic coated paper liner (Comparative Example 5) and the release liner described above (Example 5) using a #6 wire wound bar (R.D.S. Webster N.Y.). Then, a hardcoat transferable article was prepared with each as follows.

The coated film was placed on a metal plate and cured with an UV light through the hardcoat layer by irradiation with a Fusion H lamp (Fusion UV Systems, Inc., Rockville, Md.) set at 100% power and using nitrogen inerting sufficient to bring the oxygen level below 100 ppm. The web speed was 20 feet per minute (6.1 m/min). The cured film was then corona treated in an air atmosphere using an Eni Power Systems Model RS-8 Surface Treater (Eni Power Systems, Rochester, N.Y.) at a setting of 500 Watts at 10 feet per minute (3 m/min). The corona treated film was coated with 3M™ 94 Tape Primer (3M Co.) using a #6 wire wound bar (R.D.S., Webster, N.Y.) and dried in a 150 degree F. (66° C.) oven for 1 minute. The primer coated film was then coated with a resin solution formed by thoroughly mixing 10.0 wt-% Paraloid™ B-82 acrylic resin (Rohm and Haas Co., Philadelphia, Pa.) and 90.0 wt-% 3M™ Thinner CGS-10 (3M Co.). This resin solution was coated onto the primer coated film using a #6 wire wound bar and dried in a 150 degree F. (66° C.) oven for one minute. The resultant coated film was then placed face to face with a sheet of 3M™ Controltac™ Plus Graphic Film Series 180-10 (2 mil thick white vinyl film; “180 Vinyl Film“; 3M Co.) and run through an Orca 1 Laminator (Pro Tech Engineering, Madison, Wis.) at 2 feet per minute (0.6 m/min) and a nip pressure of 50 psi (345 kPa). The laminator top roll temperature was 225 degrees F. (107° C.) and the bottom roll temperature was set at 36 degree F. (2° C.) (the temperature was variable, since no cooling was provided). The resultant laminated construction was allowed to cool to ambient temperature, and the liner was removed.

Upon visual inspection, the construction of Example 5 appeared to have higher gloss than the construction of Comparative Example 5. A BYK Gardner micro-TRI-gloss unit (Rivers Park II, Columbia, Md.) was then used to measure the gloss of the laminate constructions at 20 degrees. An average of 3 readings is reported along with the standard deviation in Table 2.

TABLE 2
Gloss Values

| | Gloss Units at 20 | Standard |
|---|---|---|
| Example No. | Degrees | Deviation |
| Comparative Ex. 5 | 41.5 | 1.3 |
| 5 | 62 | 0.1 |

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

We claim:

1. A hardcoat film article comprising a cured hardcoat layer disposed on a release liner, the release liner comprising a release material formed by irradiating a release material precursor,
wherein the release material precursor has a shear storage modulus of about 1×10² to about 3×10⁶ Pa when measured at 20° C. and at a frequency of 1 Hz, and
wherein the release material has a contact angle of 15° or more, as measured using a mixed solution of methanol and water (volume ratio 90:10) having a wet tension of 25.4 mN/m.

2. The hardcoat film article of claim 1 wherein the release material comprises polyolefin, poly(meth)acrylate, polyvinyl ether, or a combination thereof.

3. The hardcoat film article of claim 2 wherein the release material comprises polyolefin formed from at least one olefin monomer having about 2 to about 12 carbon atoms.

4. The hardcoat film article of claim 2 wherein the release material precursor comprises a poly(meth)acrylate copolymer derived from a monomer component comprising at least one first alkyl(meth)acrylate containing an alkyl group having about 12 to about 30 carbon atoms and at least one second alkyl(meth)acrylate containing an alkyl group having about 1 to about 12 carbon atoms.

5. The hardcoat film article of claim 2 wherein the release material precursor comprises a poly(meth)acrylate copolymer derived from a monomer component comprising at least one alkyl(meth)acrylate containing a straight alkyl group and at least one monomer component containing an alkyl(meth)acrylate containing a branched alkyl group having from about 8 to about 30 carbon atoms.

6. The hardcoat film article of claim 1 wherein the release material precursor comprises a poly(meth)acrylate ester having a group capable of being activated by ultraviolet radiation.

7. The hardcoat film article of claim 6 wherein the poly(meth)acrylate ester has a group capable of being activated by ultraviolet radiation derived from benzophenone.

8. The hardcoat film article of claim 6 wherein the poly(meth)acrylate ester is derived from a monomer component comprising at least one first alkyl(meth)acrylate containing an alkyl group having about 12 to about 30 carbon atoms, at least one second alkyl (meth)acrylate containing an alkyl group having about 1 to about 12 carbon atoms, and at least one (meth)acrylate ester having a group capable of being activated by ultraviolet radiation.

9. The hardcoat film article of claim 6 wherein the poly(meth)acrylate ester is derived from a monomer component comprising an alkyl(meth)acrylate containing a branched alkyl group having about 8 to about 30 carbon atoms, and a (meth)acrylate ester having a group capable of being activated by ultraviolet radiation.

10. The hardcoat film article of claim 9 wherein the (meth)acrylate containing a branched alkyl group is selected from the group consisting of 2-heptylundecyl acrylate, 2-ethylhexyl(meth)acrylate, isononyl(meth)acrylate, and combinations thereof.

11. The hardcoat article of claim 1 wherein the release material is provided on a liner substrate comprising polyester, polyolefin, or paper.

12. The hardcoat article of claim 1 wherein the hardcoat layer is made from a cross-linkable monomer selected from the group consisting of multifunctional acrylates, urethanes, urethane acrylates, siloxanes, and epoxies.

13. The hardcoat article of claim 1 wherein the hardcoat layer comprises a plurality of inorganic nanoparticles.

14. The hardcoat article of claim 13 wherein the hardcoat layer comprises a plurality of silica nanoparticles.

15. The hardcoat article of claim 1 wherein the cured hardcoat layer comprises a cross-linked multifunctional polyacrylate and a polyurethane.

16. The hardcoat article of claim 1 wherein the cured hardcoat layer is transparent.

17. The hardcoat article of claim 1 further comprising an adhesive on at least a portion of the cured hardcoat layer.

18. The hardcoat article of claim 17 further comprising a second release liner disposed on the adhesive.

19. The hardcoat article of claim 1 further comprising a thermoplastic layer on the cured hardcoat layer.

20. The hardcoat article of claim 19 further comprising an adhesive on at least a portion of the thermoplastic layer.

21. The hardcoat article of claim 20 further comprising a second release liner disposed on the adhesive.

22. The hardcoat article of claim 19 wherein the thermoplastic layer has a thickness of about 0.5 to about 20 micrometers.

23. The hardcoat article of claim 19 wherein the thermoplastic layer further comprises an ink receptive material forming an ink receptive thermoplastic layer.

24. The hardcoat article of claim 23 further comprising a graphic printed on the ink receptive thermoplastic layer.

25. The hardcoat article of claim 24 wherein the graphic is disposed between the ink receptive thermoplastic layer and the cured hardcoat layer.

26. The hardcoat article of claim 24 wherein the graphic is formed from a solvent-based ink.

27. The hardcoat article of claim 24 wherein the graphic is formed from an ultraviolet ink.

28. The hardcoat article of claim 23 wherein the ink receptive thermoplastic layer comprises a polyacrylate.

29. The hardcoat article of claim 24 further comprising an adhesive on at least a portion of the ink receptive thermoplastic layer.

30. The hardcoat article of claim 29 further comprising a second release liner disposed on the adhesive.

31. A method for making a hardcoat film article comprising coating a hardcoat composition onto a release liner to form a hardcoat layer, the release liner comprising a release material formed by irradiating a release material precursor,
wherein the release material precursor has a shear storage modulus of about 1×10² to about 3×10⁶ Pa when measured at 20° C. and at a frequency of 1 Hz, and
wherein the release material has a contact angle of 15° or more, as measured using a mixed solution of methanol and water (volume ratio 90:10) having a wet tension of 25.4 mN/m.

32. The method of claim 31 further comprising curing the hardcoat layer to form a cured hardcoat film article.

33. The method of claim 32 further comprising disposing a thermoplastic layer on the cured hardcoat layer.

34. The method of claim 33 wherein the thermoplastic layer further comprises an ink receptive material forming an ink receptive thermoplastic layer.

35. The method of claim 34 further comprising a graphic printed on the ink receptive thermoplastic layer.

36. A method of using a cured hardcoat film article comprising:
(a) providing a cured hardcoat film article comprising
(i) a release liner, the release liner comprising a release material formed by irradiating a release material precursor, wherein the release material precursor has a shear storage modulus of about 1×10² to about 3×10⁶ Pa when measured at 20° C. and at a frequency of 1 Hz, and wherein the release material has a contact angle of 15° or more, as measured using a mixed solution of methanol and water (volume ratio 90:10) having a wet tension of 25.4 mN/m, and
(ii) a cured hardcoat layer disposed on the release liner; and
(b) removing the release liner.

37. The method of claim 36 further comprising adhering the cured hardcoat film article to a graphic substrate before removing the release liner.

38. The method of claim 36 wherein the cured hardcoat film article further comprises a thermoplastic layer on the cured hardcoat layer.

39. The method of claim 38 wherein the thermoplastic layer comprises an ink receptive material.

40. The method of claim 39 wherein the cured hardcoat film article further comprises a graphic printed on the thermoplastic layer.

41. The method of claim 38 further comprising adhering the cured hardcoat film article to a substrate before removing the release liner.
